(19) United States
(12) Patent Application Publication
(10) Pub. No.: US 2008/0172614 A1
(43) Pub. Date: Jul. 17, 2008

(54) ACTION-BASED MENUS FOR A PORTABLE MEDIA DEVICE

(75) Inventor: Jonathan Nelson, Seattle, WA (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(73) Assignee: VARIA MOBIL LLC, Seattle, WA (US)

(21) Appl. No.: 11/971,035

(22) Filed: Jan. 8, 2008

Related U.S. Application Data
(60) Provisional application No. 60/883,983, filed on Jan. 8, 2007.

(51) Int. Cl. G06F 3/048

(52) U.S. Cl. 715/716

(57) ABSTRACT

A software and/or hardware facility for presenting action-based menus on a portable media player. An action-based menu is a list of action options contextually displayed to a user of the portable media player that includes actions that are relevant to the particular piece of media or group of media. Each action in the action-based menu is selectable by the user, and the facility initiates an activity corresponding to a selected action. Other embodiments are disclosed and claimed.

### CROSS-REFERENCE TO RELATED APPLICATION(S)

This application claims priority to, and incorporates by reference in its entirety, U.S. Provisional Application No. 60/883,983, entitled “Action-Based Menus for a Portable Media player”, filed on Jan. 8, 2007.

### BACKGROUND

Portable media players are increasing in popularity. A portable media player is a transportable device that plays one or more media file types, including text, audio, video, graphics, animation, images, interactive, and other media file types.

In most portable media players, users access pieces of media on the media player by navigating through a hierarchical menu structure. For example, if a user desires to access a song on the media player, the user may first select a category (such as “Artists”) from a main menu, then select an artist's name from the “Artists” menu, and finally select a song by the artist from the menu associated with the artist's name. The user's selections are confined by the hierarchical menu structure, and the user is limited to a small number of options to locate desired media. Unfortunately, as the amount of media that is stored on or accessible by portable media players continues to grow, the utility of a hierarchical menu structure to locate desired media has diminished. As the number of pieces of media on a user's media player reaches hundreds or even thousands, the limited choices in a hierarchical menu increases the amount of time that it takes for the user to access a desired piece of media.

### BRIEF DESCRIPTION OF THE DRAWINGS

FIG. 1 is a block diagram of a representative environment in which the facility operates, in accordance with various embodiments.

FIG. 2 is a representative screen shot depicting a contextually displayed action-based menu associated with an artist stored on or accessible by a portable media player, in accordance with various embodiments.

FIG. 3 is a representative screen shot depicting a contextually displayed action-based menu associated with an album stored on a portable media player, in accordance with various embodiments.

FIG. 4 is a representative screen shot depicting a contextually displayed action-based menu associated with an album accessible by a portable media player via a network, in accordance with various embodiments.

FIG. 5 is a representative screen shot depicting a contextually displayed action-based menu associated with a song stored on a portable media player, in accordance with various embodiments.

FIG. 6 is a representative screen shot depicting a contextually displayed action-based menu associated with a song accessible by a portable media player via a network, n accordance with various embodiments.

FIG. 7 is a representative screen shot depicting a contextually displayed action-based menu associated with a video accessible by a portable media player via a network, n accordance with various embodiments.

FIG. 8 is a representative screen shot depicting a contextually displayed-based menu associated with a playlist stored on or accessible by a portable media player, n accordance with various embodiments.

FIG. 9 is a representative screen shot depicting a contextually displayed action-based menu associated with a podcast stored on or accessible by a portable media player, n accordance with various embodiments.

### DETAILED DESCRIPTION OF ILLUSTRATIVE EMBODIMENTS

A software and/or hardware facility for contextually presenting action-based menus on a portable media player is described. An action-based menu is a list of options displayed to a user of a portable media player that includes actions that are relevant to the particular piece of media or group of media associated with the action-based menu. Each action in the action-based menu is selectable by the user, and the facility will initiate an activity corresponding to the action when the action is selected by the user. An action-based menu provides the user with the most relevant actions related to an associated piece of media or group of media, thereby reducing the number of operations a user must take to accomplish a desired action.

The following description provides specific details for a thorough understanding of, and enabling description for, various embodiments of the technology. One skilled in the art will understand that the technology may be practiced without many of these details. In some instances, well-known structures and functions have not been shown or described in detail to avoid unnecessarily obscuring the description of the embodiments of the technology. It is intended that the terminology used in the description presented below be interpreted in its broadest reasonable manner, even though it is being used in conjunction with a detailed description of certain embodiments of the technology. Although certain terms may be emphasized below, any terminology intended to be interpreted in any restricted manner will be overtly and specifically defined as such in this Detailed Description section.

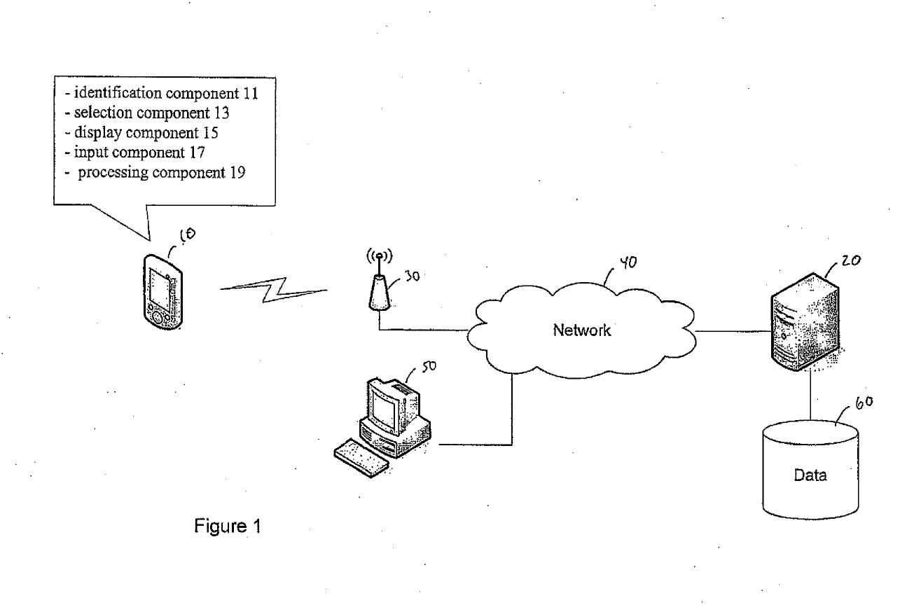

FIG. 1 depicts a representative environment in which the facility operates, in accordance with various embodiments. A portable media player 10 is configured to store media, which may be of various media types, text, graphics, audio, video and so forth. The portable media player/device 10 may also access media from a media service 20 via a wireless access point 30 and a network 40. Alternatively or additionally, a computer 50 may access media from a media service 20 via the network 40. The facility may transmit the media between the computer 50 and the portable media device 10, such as when the media stored on the computer are synched with the media that are on the portable media player. Information about a user and/or the user's portable media device may be stored in a data area 60 that is coupled to the media service 20. The information may include the identity of media stored on the user's media player, a record of media accessed by the user, and other information.

As will be described in more detail below, portable media player/device 10 is endowed with teachings of the disclosure to practice an action-based menu system of the device, to improve a user's experience associated with playing media using the player/device.

An action-based menu on a portable media player includes actions that are relevant to the particular piece of media or group of media associated with the action-based menu. Actions that may be included in an action-based menu include, but are not limited to:

Listen to an artist, album, song, podcast, radio station, or other piece of media or group of media.

List the albums or songs by an artist; songs on an album; episodes in a podcast; or other related metadata about the media represented by the menu page.

Add the artist, album, song, podcast, or other piece of media or group of media to a queue of media to be played.

Display a biography of an artist or author.

Display more songs or albums by an artist; videos by an artist; episodes in a podcast; or other piece of media or group of media.

Display similar songs, albums, artists, videos, podcasts, images, radio stations, games, or other pieces of media or groups of media.

Delete a song, artist, album, video, podcast, image, game, or other piece of media or group of media.

Sample a song, album, video, podcast, image, game, or other piece of media or group of media

Purchase a song, album, video, podcast, image, game, or other piece of media or group of media.

Add a song, album, artist, video, podcast, image, game, or other piece of media or group of media to a media channel or playlist.

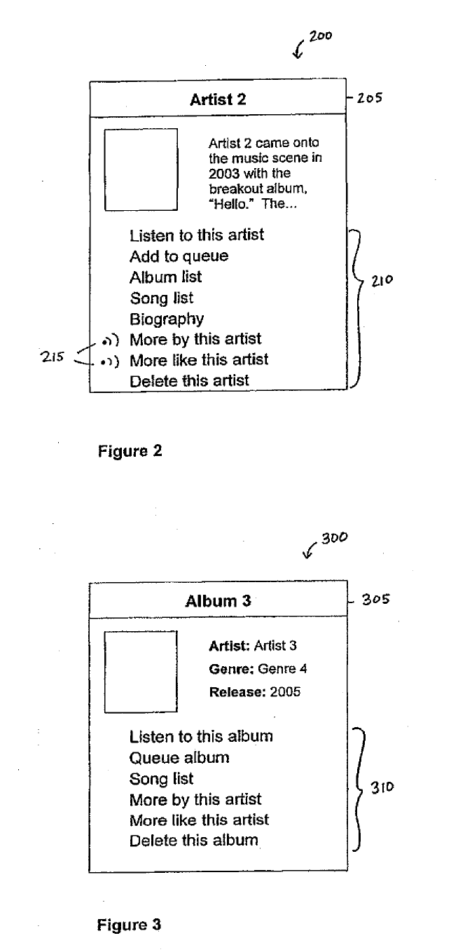

Actions included in an action-based menu for a piece of media or group of media, are based on one or more contexts that are relevant to the piece of media or group of media. In some examples, action-based menu items are based on a category related to the piece of media or group of media. For example, action-based menu items associated with an artist may be different than action-based menu items associated with an album, although identical or similar items may be displayed for both categories. FIGS. 2-9 are representative screen shots of action-based menus in which action-based menu items are based on a category related to the piece of media or group of media associated with the action-based menu, in accordance with various embodiments. Categories may include artist, album, song, genre, video, playlist, podcast, radio station, image, text, game, or other category.

FIG. 2 is a representative screen shot 200 of an action-based menu that may be contextually displayed when a user selects a particular artist, such as “Artist 2,” of media that is stored on or accessible by the media player, in accordance with various embodiments. FIG. 2 depicts an “Artist 2” screen 205 with an action-based menu that includes a list of action-based items 210. These action-based items may include options to listen to music by the artist, add the artist's music to a queue of music to be played, view a list of albums by the artist, view a list of songs by the artist, view the artist's biography, view more songs by the artist, view more artists or songs similar to the artist, delete the artist from the media player, and other action-based items.

FIG. 3 is a representative screen shot 300 of an action-based menu that may be contextually displayed when the user selects a particular album, such as “Album 3,” that is stored on the media player, in accordance with various embodiments. FIG. 3 depicts an “Album 3” screen 305 with an action-based menu that includes a list of action-based items 310. These action-based items may include options to listen to the album, add the album to a queue of music to be played, view a list of songs on the album, view more albums by the artist, view more artists or songs that are similar to the selected artist, delete the album from the media player, and other action-based items.

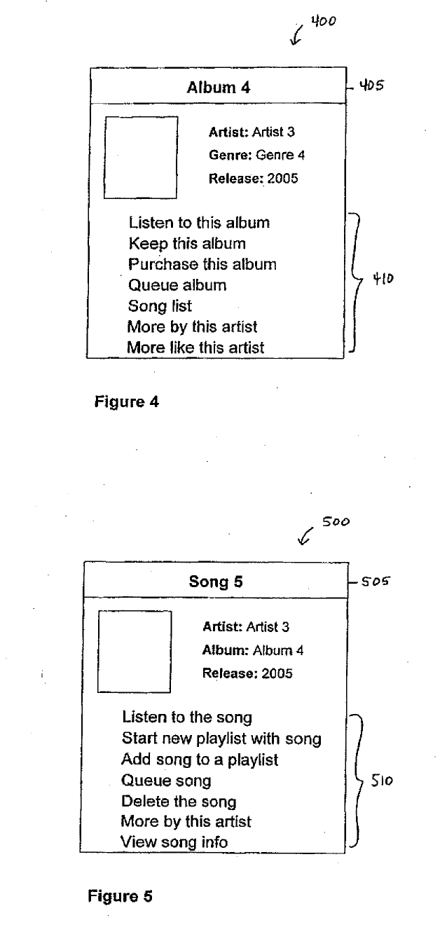

In some examples, the action-based menu items included in an action-based menu may differ depending on whether a piece of media or group of media associated with the action-based menu is stored on the media player or, alternatively, whether the piece of media or group of media is accessible by, but not stored on, the media player. For example, the action-based menu items included in an action-based menu may differ for an album that is stored on a media player (i.e., a local album) and an album that is accessible via a network, such as the Internet. FIG. 3, described above, is an example of an action-based menu that includes action-based items for a local album, while FIG. 4 is an example of an action-based menu that includes action-based items for a network-accessible album, in accordance with various embodiments.

FIG. 4 is a representative screen shot 400 that depicts an “Album 4” screen 405 with an action-based menu contextually displayed that includes a list of action-based items 410 for a network-accessible album, in accordance with various embodiments. These action-based items may include options to listen to the album, keep the album (i.e., store the album on the media player), purchase the album, add the album to a queue of music to be played, view a list of songs on the album, view more albums by the artist, view more artists or songs that are similar to the selected artist, and other action-based items. Some of the action-based menu items presented for a network-accessible album, as depicted by FIG. 4, are identical to or similar to the items presented for a local album, as depicted by FIG. 3. Other action-based menu items are presented only for a local album or, alternatively, only for a network-accessible album, as these items are only applicable in either the local or the network context.

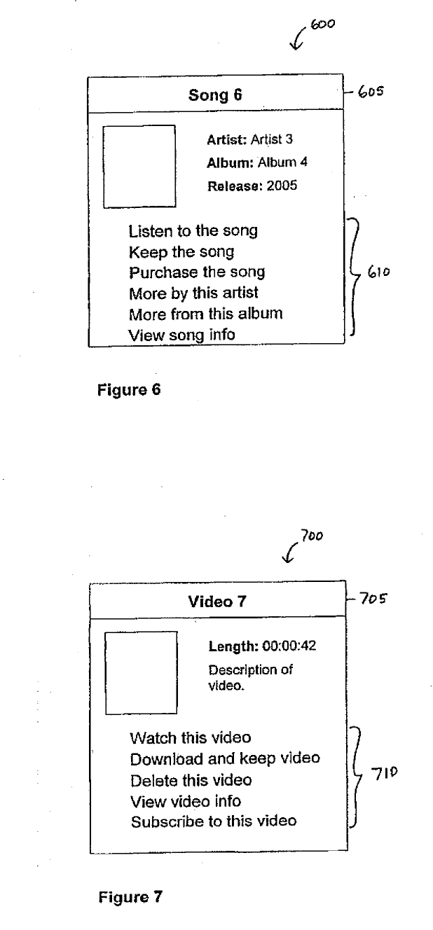

Similarly, FIG. 5 is an example of an action-based menu contextually displayed that includes action-based items for a local song (i.e., a song that is stored on the media player), while FIG. 6 is an example of an action-based menu that includes action-based items for a network-accessible song, in accordance with various embodiments.

FIG. 5 is a representative screen shot 500 that depicts a “Song 5” screen 505 with an action-based menu contextually displayed that includes a list of action-based items 510 for a local song, in accordance with various embodiments. These action-based items may include options to listen to the song, start a new playlist with the song, add the song to a playlist, add the song to a queue of music to be played, delete the song from the media player, view more songs by the artist, view information related to the song, and other action-based items.

FIG. 6 is a representative screen shot 600 that depicts a “Song 6” screen 605 with an action-based menu contextually displayed that includes a list of action-based items 610 for a network-accessible song, in accordance with various embodiments. These items may include options to listen to the song, keep the song (i.e., store the song on the media player), purchase the song, view more songs by the artist, view more songs from the album, view information related to the song, and other action-based items.

FIGS. 7-9 are representative screen shots of contextually displayed action-based menus in which action-based menu items are based other categories, including video, playlist, and podcast, in accordance with various embodiments.

FIG. 7 is a representative screen shot 700 of an action-based menu that may be contextually displayed when the user selects a video, such as “Video 7,” that is stored on or accessible by the media player, in accordance with various embodiments. FIG. 7 depicts a “Video 7” screen 705 with an action-based menu that includes a list of action-based items 710. These action-based items may include options to watch the video, download and keep the video, delete the video, view information related to the video, subscribe to the video, and other action-based items.

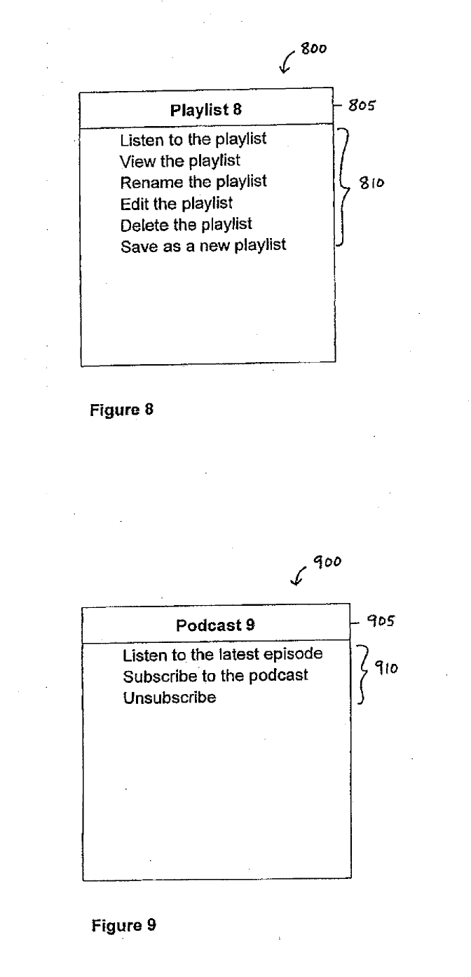

FIG. 8 is a representative screen shot 800 of an action-based menu that may be contextually displayed when the user selects a playlist, such as “Playlist 8,” that is stored on or accessible by the media player, in accordance with various embodiments. FIG. 8 depicts a “Playlist 8” screen 805 with an action-based menu that includes a list of action-based items 810. These action-based items may include options to listen to the playlist, view the playlist, rename the playlist, edit the playlist, delete the playlist, save the playlist as a new playlist, and other action-based items.

FIG. 9 is a representative screen shot 900 of an action-based menu that may be contextually displayed when a user selects a podcast, such as “Podcast 9,” that is stored on or accessible by the media player, in accordance with various embodiments. FIG. 9 depicts a “Podcast 9” screen 905 with an action-based menu that includes a list of action-based items 910. These action-based items may include options to listen to the latest podcast episode, subscribe to the podcast, unsubscribe to the podcast, and other action-based items.

The actions that are relevant to a piece of media or group of media associated with an action-based menu under various contexts, including the contexts themselves, may be identified in one or more ways. Relevant actions may be identified by the designer of the portable media player software, by a wired or wireless service accessed via the media player, by the media player itself, or by the user, who can select actions he or she would like to initiate from a particular action-based menu. Those skilled in the art will appreciate that relevant actions may also be determined and/or modified in a variety of other ways, or in a combination of these and other ways.

Once identified, action-based menu items may be contextually presented to a user by the facility in a variety of ways. The actions may be represented by text, graphics, icons, and/or other representations. The facility may present the action-based items on a primary screen that is displayed to the user after the user selects an artist, album, or other node in the menu structure that is used to navigate the media stored on or accessible by the media player. The action-based items may also or alternatively be presented in a popup box or window that appears after the user selects an artist, album, or other node in the menu structure. The action-based menu items may also or alternatively be presented on a pane (i.e., portion) of the main screen that appears after the user selects an artist, album, or other node in the menu structure. Those skilled in the art will appreciate that the action-based menu items may be presented to the user in other ways, or in a combination of these and other ways.

When displayed to a user, action-based menu items may be listed in a specified order. In some examples, action-based items are listed in an order that corresponds to the likelihood that the user will select the action-based item. The likelihood that the user will select the action-based item may be based on an overall popularity of the action-based item relative to other action-based items, as determined by the facility, a network site or service, or another entity. That is, more popular action-based items may be displayed at the top of the list, and less popular action items displayed at the bottom of the list. Alternatively or additionally, the likelihood that the user will select the action-based item may be based on information that the facility knows about the particular user, such as media accessed by the user, past actions selected by the user with respect to a piece of media or group of media, user preferences, and other information.

Action-based items may also be listed in one or more other specified orders. In some examples, action-based menu items may be listed in alphabetical or numerical order. Alternatively, action-based menu items may be listed in an order that has been predefined by the user. As another alternative, action-based menu items may be listed in a random order. Those skilled in the art will appreciate that the action-based menu items may be presented to the user in another order, or in a combination of these and other ways.

In some examples, the facility may present two or more levels of action-based menus to the user. A first level action-based menu may contain basic and/or primary action-based menu items related to the piece of media or group of media associated with the action-based menu. A second or subsequent level action-based menu may contain additional and typically less-used action-based menu items related to the piece of media or group of media associated with the action-based menu. The user may access the second or subsequent level menus by pressing and holding a button on the player, by selecting an option from a menu (e.g., “more options” on the first level menu), or by making another type of request (e.g., a verbal command).

The list of action-based menu items included in an action-based menu and displayed to the user by the facility may be static or dynamic. In some examples, the same action-based menu items may be displayed to the user, and the items may be displayed in the same order each time the user views the action-based menu. In other examples, the action-based menu items displayed to the user may be modified, presented to the user in a different order, or both, each time the user views the action-based menu. For example, if the user selects Action B, an action-based item that is listed second in an action-based menu, more often than Action A, an action-based item that is listed first in the action-based menu, the facility may subsequently list Action B before Action A in the action-based menu.

In some examples, the facility will initiate an activity corresponding to an action-based item selected by a user regardless of whether the user's media player is connected, via a wired or wireless connection, to a network site or service. Alternatively, the facility may require that the media player be connected to a network site or service before it will initiate an activity corresponding to an action-based item selected by the user. For example, a network connection may be required before the facility can search a network site or service for other media that may be accessible by the media player. Examples of action-based items for which a network connection may be required include “more by this artist,” “more like this artist,” and other items.

When a network connection is required before the facility can initiate an activity corresponding to an action-based item, the facility may indicate to the user the network connection requirement in a variety of ways. A network connection requirement may be represented by text, graphics, icons, and/or other representations. FIG. 2 provides an example of an icon 215 that may be used to indicate to the user that a network connection is required before the facility can initiate an activity corresponding to an action-based item, in accordance with various embodiments. FIG. 2 depicts the icon 215 next to the action-based items “More by this artist” and “More like this artist” to indicate that the user's media player must be connected to a network site or service for the facility to perform an activity corresponding to these items.

Referring back to FIG. 1, in various embodiments, portable player may be endowed with an identification component 11 to identify the context, a selection component 13 to select the actions, a display component 15 to display the action-based menu, an input component 17 to receive user selection, and a processing component 19 to initiate the activity corresponding to the selected action, as earlier described. Components 11-19 are operatively coupled to each other. In various embodiments, one or more of the components 11-19 may be combined or have split. In various embodiments, the various components may be implemented in hardware and/or software. In various embodiments, the various components may be housed in a housing that is palm-sized designed for portability.

From the foregoing, it will be appreciated that specific embodiments of the invention have been described herein for purposes of illustration, but that various modifications may be made without deviating from the spirit and scope of the invention. Accordingly, the invention is not limited except as by the appended claims.

We claim:

1. A portable media device for presenting an action-based menu on a portable media device, the system comprising:
an identification component for identifying a context related to a media file or group of media files selected by a user of the portable media device;
a selection component communicatively coupled to the identification component for selecting one or more actions relevant to the media file or group of media files under the identified context;
a display component communicatively coupled to the selection component for displaying the selected one or more actions to the user;
an input component for receiving a selection by the user of one of the displayed actions; and
a processing component communicatively coupled to the input component for initiating an activity corresponding to the action selected by the user.

2. The portable media device of claim 1 wherein the one or more actions comprises playing the media file or group of media files,
displaying metadata related to the media file or group of media files;
adding the media file or group of media files to a queue of media to be played by the media device;
displaying a biography of an artist or author of the media file or group of media files;
displaying more media related to the media file or group of media files;
purchasing the media file or group of media files;
adding the media file or group of media files to a media channel; or adding the media file or group of media files to a media channel.

3. The portable media device of claim 1 wherein the context is a selected one of artist, album, song, genre, video, podcast, radio station, image, text, game, or playlist.

4. The portable media device of claim 1 wherein the selection component is component is configured to select the one or more actions based on whether the media file or group of media files is stored on the media device or whether the media file or group of media files is only accessible by, but not stored on, the media device.

5. The portable media device of claim 1 wherein the selection component is configured to select the one or more of the actions from actions provided by a software designer of the media device, or a network site or service accessed by the media device via a wired or wireless network connection.

6. The portable media device of claim 1 wherein the selection component is configured to select the one or more of the actions taking into considerations selection inputs provided by the user.

7. The portable media device of claim 1 wherein the selection component is configured to display the one or more actions in an order that corresponds to the likelihood that the user will select the actions, wherein an action that is more likely to be selected by the user will be displayed before an action that is less likely to be selected by the user.

8. The portable media device of claim 1 wherein the selection component is configured to display the actions in an order predefined by the user.

9. The portable media device of claim 1 wherein the selection component is configured to display the one or more actions in an hierarchical manner, displaying primary actions in a first menu and secondary actions in a subsequent menu.

10. The portable media device of claim 1 wherein selection component is configured to display the one or more actions in a dynamic order.

11. The portable media device of claim 1 wherein the processing component is configured to initiate an activity associated with a selected action regardless of whether the media device is connected to a network site or service via a wired or wireless network connection.

12. The portable media device of claim 1 wherein the processing component is configured to initiate an activity associated with a selected action only if the media device is connected to a network site or service via a wired or wireless network connection.

13. A method of presenting an action-based menu on a portable media player, the method comprising:
identifying by the portable media player a context related to a media file or group of media files selected by a user;
selecting by the portable media player one or more actions relevant to the identified context;
displaying by the portable media player the selected actions to the user;
receiving by the portable media player a selection by the user of one of the displayed actions; and
initiating by the portable media player an activity corresponding to the action selected by the user.

14. The method of claim 13 wherein the initiating comprises playing the media file or group of media files;
displaying metadata related to the media file or group of media files;
adding the media file or group of media files to a queue of media to be played by the media device;
displaying a biography of an artist or author of the media file or group of media files;
displaying more media related to the media file or group of media files;
purchasing the media file or group of media files; or adding the media file or group of media files to a media channel.

15. The method of claim 13, wherein the context is selected from among artist, album, song, genre, video, podcast, radio station, image, text, game, or playlist.

16. The method of claim 13, wherein the selecting is based on whether the media file or group of media files is stored on the media device or whether the media file or group of media files is only accessible by, but not stored on, the media device.

17. The method of claim 13, wherein the selecting comprises selecting the one or more actions from actions provided by a software designer of the media device or a network site or service accessed by the media device via a wired or wireless network connection.

18. The method of claim 13, wherein the selecting comprises selecting the one or more actions taking into consideration selection inputs provided by the user.

19. The method of claim 13, wherein the displaying comprises displaying the one or more actions in an order that corresponds to the likelihood that the user will select the actions, wherein an action that is more likely to be selected by the user will be displayed before an action that is less likely to be selected by the user.

20. The method of claim 13, wherein the displaying comprises displaying the one or more actions in an order predefined by the user.

21. The method of claim 13, wherein the displaying comprises displaying the one or more actions in an hierarchical manner, displaying primary actions in a first menu and secondary actions in a subsequent menu.

22. The method of claim 13 wherein the displaying comprises displaying the one or more actions in a dynamic order.

23. The method of claim 13 wherein the initiating comprises initiating an activity regardless of whether the media device is connected to a network site or service via a wired or wireless network connection.

24. The method of claim 13, wherein the initiating comprises initiating an activity is initiated only if the media device is connected to a network site or service via a wired or wireless network connection.

25. An article of manufacture comprises a computer readable storage medium, and content stored therein, wherein the content is configured to enable a portable media player to practice an action-based menu method comprising
identifying by the portable media player a context related to a media file or group of media files selected by a user;
selecting by the portable media player one or more actions relevant to the identified context;
displaying by the portable media player the selected actions to the user;
receiving by the portable media player a selection by the user of one of the displayed actions; and
initiating by the portable media player an activity corresponding to the action selected by the user.
